(19) United States
(12) Patent Application Publication
(10) Pub. No.: US 2007/0280803 A1
(43) Pub. Date: Dec. 6, 2007

(54) All-metal thread locking/prevailing torque threaded fastener

(76) Inventor: Alan Pritchard, Turre (ES)

Correspondence Address: CESARI AND MCKENNA, LLP, 88 BLACK FALCON AVENUE, BOSTON, MA, 02210, US

(21) Appl. No.: 11/446,496

(22) Filed: Jun. 2, 2006

(51) Int. Cl. F16B 35/04

(52) U.S. Cl. 411/411

(57) ABSTRACT

This invention provides a fastener system having an external thread cross section profile that includes a novel asymmetrical thread addendum that does not have the disadvantage of centralizing the external bolt thread in the internal nut thread cavity. By overcoming the disadvantages of prior art symmetrical thread profile, there will be seen a more useful and efficient use of the forces applied during the application of the externally threaded fastener, toward thread locking and improved resistance to loosening from outside influences such as assembly vibrations and the like. In an illustrative embodiment the addendum extends radially outward from the leading and trailing face profile of the external thread. It can be defined an associated addendum leading edge and trailing edge that are each approximately linear. The trailing face can have a radius profile in one embodiment. In further embodiments, the leading face can also be radiused.

### BACKGROUND OF THE INVENTION

1. Field of the Invention

This invention relates to all-metal thread-locking-type fasteners, and more particularly to improved thread profile geometries for such thread locking-type fasteners.

2. Background Information

Generally speaking, the object of having a specially designed fastener thread profile that can be deemed to create “thread locking” in a pre-tapped anchor nut, is that of creating an interference fit between the external threaded fastener thread and the nut thread into which the fastener is to be inserted.

The most popular type of screw or bolt that follows this principle of thread interference is designed in accordance with Woodward and is defined generally in the teachings of U.S. Pat. No. 1,451,484 (circa 1922). This particular teaching provides for is an additional thread-locking addendum that is added to the standard thread profile of an externally threaded fastener. The addendum extends radially outward from the central axis of the fastener, thereby creating interference between the major diameter of the screw/bolt thread and the major diameter of a nut thread of standard proportions. This prior art external thread profile 110 is shown by way of example in partial cross section in FIG. 1. As illustrated, the base thread 112 of the profile 110 is supplemented by the addendum 114. In this example, the addendum 114 projects at angle AA relative the axis perpendicular 116 that is shallower than the base thread angle AB. Both the lead and following faces of each thread, and the addendum, are characterized by a symmetrical profile with respect to the perpendicular 116 in this example (e.g. angles AB and AA is the same for the lead and following faces, respectively). As discussed further below, the resulting reduced cross sectional area of the addendum 114 allows the addendum to deform in contact with a mating internal thread.

There have been many dimensional developments of this system aimed generally toward improving the “locking” facility of the system and also to reduce the spread in the application torque values that are needed to effect the assembly of the fastener with a mating nut. Variations in the insertion torque have to be overcome, during the insertion of the fastener, if the locking system is to be more efficient in resisting loosening due to external forces. These variations in the insertion torque are seen as detrimental to the desire to attain a more-consistent fastener pre-load that can be developed from an assembly tightening torque that has to be contained within the torsional strength of the externally threaded fastener.

The system of a thread-locking addendum, that is symmetrical about the screw thread profile, creates radial interference including some degree of thread flank interference with the nut thread. The addendum further provides a potential for the addendum to centralize the external and internal thread profiles such that there is potential for clearances to be present between the external thread and the internal thread cavity in the nut. As shown by way of illustration in FIG. 2, the external thread 110 is effectively centered along the line 202, which also defines the radial centerline of the nut internal thread 220. Resulting leading and trailing face gaps G1 and G2 are defined between the adjacent faces of the external and internal threads.

It should be understood that this centering is an adverse condition that will result in the tensile forces which need to be applied to the externally threaded fastener in order to effect a suitable joint clamp load, being primarily carried by the thread-locking addendum and its interference pattern 230 with the nut thread cavity. Referring also to FIG. 3, in order for the forces to be transmitted in the designed manner of mating thread contact at the faces of the mating threads (contact region 310), there must occur physical deflection of the thread addendum 114. This deflection can only be achieved from the forces that are induced and are provided by a proportion of the application torque. This need further detracts from the torque that is used to withstand loosening. In this sense it is recognized that the resistance to loosening is effected from the friction that is generated between the force applied and the mating surface area. A reduction in either the surface area or force applied therefore reduces the effectiveness of the system as a thread-locking assembly. Other variables may also be introduced that may detract from the overall effectiveness of the system, such as failure strength, etc.

It should be noted that thread profile designs, which depart from the more-conventional trapezoidal geometry, although rare, have been developed to accomplish certain objectives. For example, my earlier U.S. Pat. Nos. 5,061,135 and 5,722,808 have disclosed and made claims to the use of defined profiles that achieve objectives and improvements from the use of specifically innovated designs in order to affect a desired end result. It should be noted that the teachings of U.S. Pat. No. 5,722,808 develops the innovated profile and thread system concept using a thread that is symmetrical about a perpendicular to the fastener axis. U.S. Pat. No. 5,061,135 uses a specially innovated concept that induces nut anchor material to flow in a prescribed manner when the fastener is used as a self-tapping screw.

While each of the above-described solutions is highly effective in particular applications, it is desired to provide an external thread profile that provides improved mechanical thread locking potential when the fastener is inserted and tightened into an anchor that has been provided with a pre-tapped internal thread and to further provide improved prevailing torque characteristics.

### SUMMARY OF THE INVENTION

This invention overcomes the disadvantages of the prior art by providing a thread profile in accordance with the invention that improves the ability of the externally threaded fastener to create a more consistent prevailing-on and prevailing-off torque and enhances the ability to lock together the external thread on the fastener and the internal pre-tapped thread in an anchor nut, when the externally threaded fastener is subjected to an axial pre-load. This improved system (nut and bolt assembly) better withstands tendencies to loosen and separate under externally applied forces/loads. Such benefits are achieved using a novel asymmetrical thread addendum that does not have the disadvantage of centralizing the external bolt thread in the internal nut thread cavity. By overcoming the disadvantages of prior art symmetrical thread profile, there will be seen a more useful and efficient use of the forces applied during the application of the externally threaded fastener, toward thread locking and improved resistance to loosening from outside influences such as assembly vibrations and the like. In an illustrative embodiment the addendum extends radially outward from the leading and trailing face profile of the external thread. There can be defined an associated addendum leading edge and addendum trailing edge that are each approximately linear. The trailing face can have a radius profile in one embodiment. In further embodiments, the leading face can also be radiused.

### BRIEF DESCRIPTION OF THE DRAWINGS

The features of the present invention are set forth with particular reference to the appended claims. The organization and manner of the invention together with further objects and advantages thereof may best be understood by reference to the following description taken in connection with the accompanying drawings in which like reference numerals identify like elements and in which:

FIG. 1, already described, is a fragmentary side cross section of a thread profile, including an addendum in accordance with the prior art;

FIG. 2, already described, is a schematic cross section of an external thread and mating internal nut thread showing the potential for the addendum to centralize the external thread of the fastener in the internal thread of the nut cavity, in accordance with the prior art;

FIG. 3, already described, is a schematic cross section of an external thread and mating internal thread showing that the thread addendum has need to deflect in order for the basic mating thread forms to achieve surface contact, in accordance with the prior art;

FIG. 4 is a side elevation view of a fastener including an asymmetrical thread in accordance with an illustrative embodiment of this invention;

FIG. 5 is a fragmentary side cross section showing the free entry tapered lead portion of the fastener of FIG. 4 and the operation by which the fastener engages a pre threaded internal anchor nut;

FIG. 6 is a schematic side cross section of the thread profile in accordance with an illustrative embodiment together with a profile of the internal nut thread profile into which the fastener is inserted detailing the point contact that is maintained at the initial assembly stage and prior to any pre-load being introduced;

FIG. 7 is a schematic cross section perpendicular to the fastener's central axis that highlights the contact that is made where the external thread defines a lobular thread-forming profile and the internal thread is generally circular;

FIG. 8 is a schematic of the thread profile in accordance with the present invention that shows an asymmetrical thread addendum that is included on a basic fastener thread profile where the forward and trailing faces of the fastener are both of a radius thread profile design;

FIG. 9 is a cross section showing an indentation formed by the addendum in engagement in accordance with FIG. 8; and

FIG. 10 is a schematic cross section of a thread profile according to an alternate embodiment of the present invention in which the novel asymmetrical thread addendum is applied to a basic fastener thread profile having forward and trailing faces with a radius thread profile design.

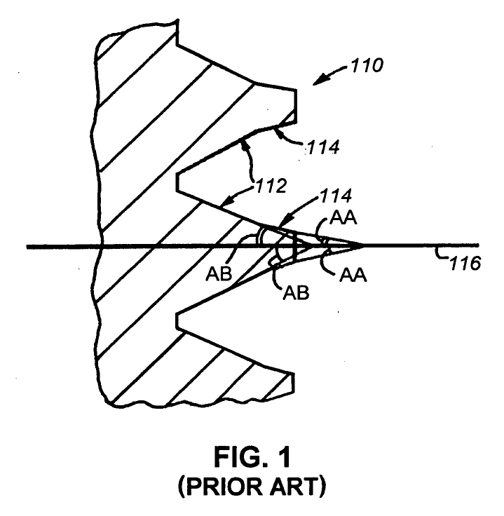

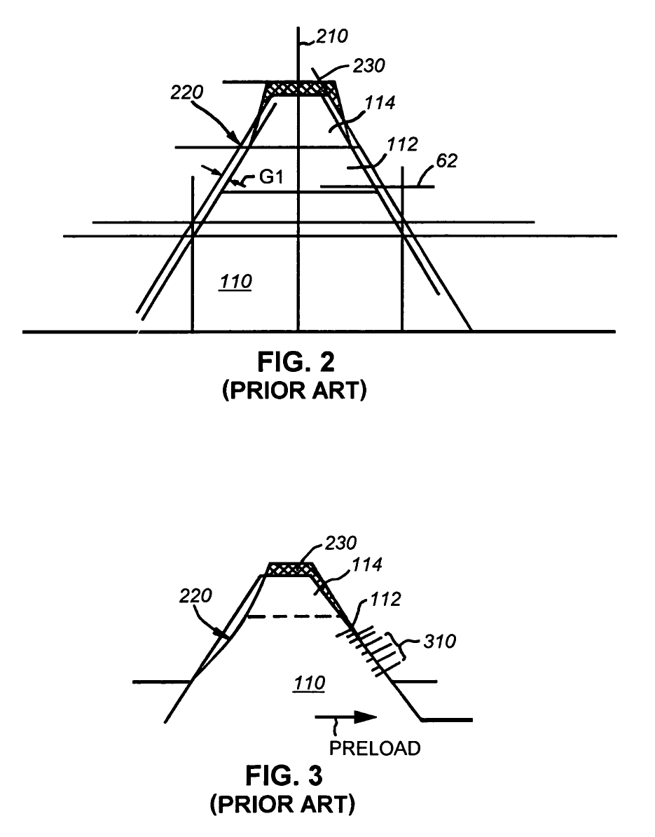

### DETAILED DESCRIPTION OF ILLUSTRATIVE EMBODIMENTS

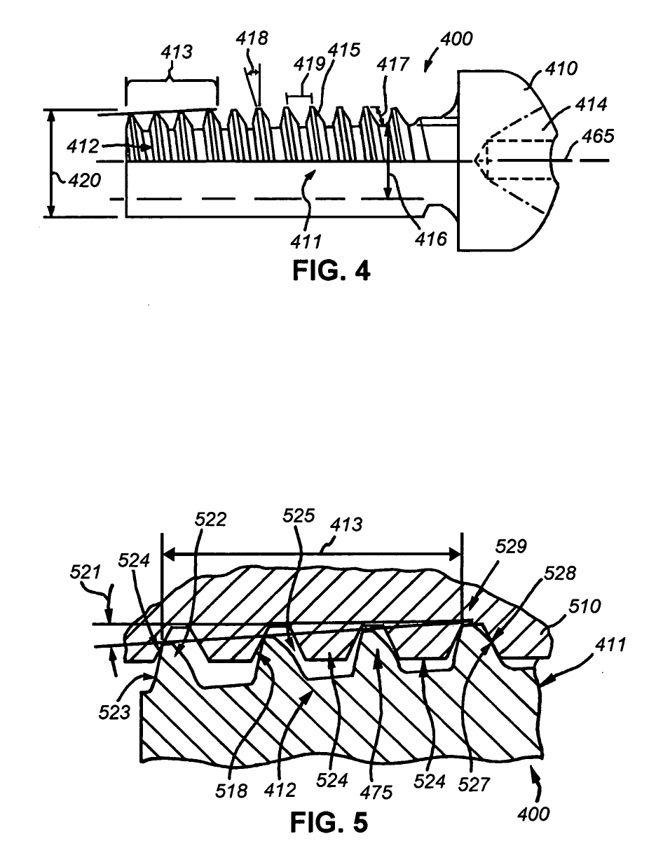

Referring now to FIG. 4 of the drawings, there is shown a thread-locking/prevailing torque fastener or screw 400 in accordance with the invention having a head 410 a shank or body portion 411 and tapered lead entry portion 412.

The head 410 may be of any desired type and may have a conventional cruciform type recess 414 or a cross slot, or be provided with an external wrench engageable formation, or may contain any other system that will allow rotational movement to be transmitted to the screw 400 through a fastener driving system.

The illustrated shank 411 is generally of a lobular cross section form for use in roll-forming internal threads in an appropriately-sized nut hole, and affording a self-locking functionality to the screw 400 in both roll-formed and pre-cut internal threads. One example of a multi-lobed cross-section, having three such lobes, is the Trilobular™ line of self-tapping screws developed by, and available through, Research Engineering & Manufacturing Inc. of Middletown, R.I. and Conti Fasteners AG of Switzerland. The shank 411 also defines a tapered entry end portion 412 that is illustrated as encompassing an end portion length 413. The present invention is not limited to this tapered lead entry portion but the advantages of such an arrangement is described further below, particularly where the threaded fastener is inserted into a pre-tapped nut anchor of standard proportions.

The shank 411 has a non-symmetrical thread 415 formed thereon over the whole length of the shank 411. Alternatively, the inventive thread 415 may extend over only a portion of the shank 411.

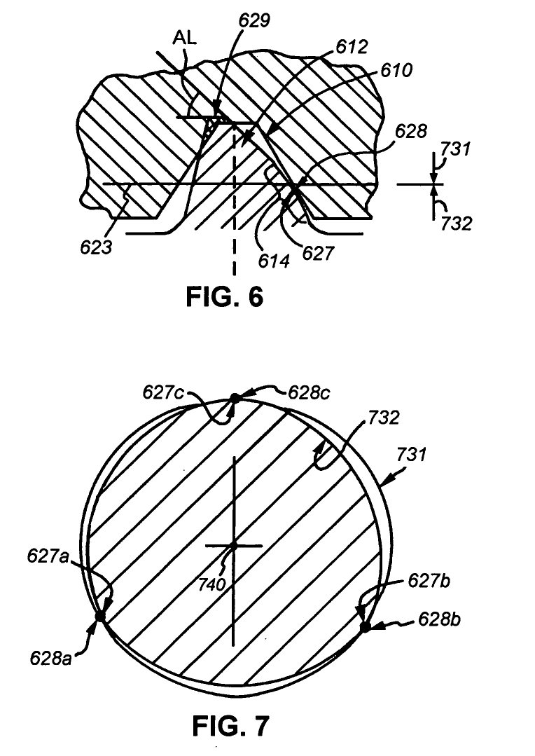

The thread 415 is generated on a helical form around a lobular core (spanning the width 416—refer also to FIG. 7 for lobular profile) in a manner that contains the thread height 417 as being of a constant magnitude for a given size of fastener.

The magnitude of the helix angle or spiral angle 418 is determined from the relationship between the thread pitch 419 and the outside diameter 420 of the fastener thread is 415. In the various embodiments described herein, the pitch 419 is defined in accordance with that of the pre-tapped thread that is the choice of the assembly fabricator. (For example: U.N.F., U.N.C., B.S.F., B.S.W., M (metric profile) and/or others).

Referring now to FIG. 5, there is shown an enlarged sectional illustration of the tapered lead entry end 412 of the fastener shank 411, and the way in which it develops an advantage when the fastener is inserted into a pre-threaded nut element 510 of standard proportions.

The tapered lead entry portion 412 extends for an axial length 413 as described above. The taper angle 521 provides for a free rotation of the screw thread 415 in the parallel nut thread 524 over a rotational range of between two and four fastener rotations. During the insertion of the screw thread 515 the thread addendum 522, which is non-symmetrical, and the leading thread profile 523, are encouraged to make contact along the non-loaded face 518 of the nut thread 524. As the fastener 400 increases its axial engagement in the nut thread 524, there is a progressive decrease in the gap 525 between the internal and external fastener threads that will ultimately result in the curved thread surface 527 (adjacent the main body of the shank 411) making contact with the face 528 of the nut thread 524. This contact position being maintained on all of the subsequent threads that become engaged to form the assembly. At the initial contact of the curved thread surface of the screw thread with the straight side of the nut thread, there will be introduced a condition of mating thread interference 529, at the major diameters of the mating threads. (See FIG. 6 for additional illustrations of this condition). This feature provides for a condition that is known to those of ordinary skill in fastener design and assembly, as “prevailing torque.” The magnitude of this prevailing torque generally increases, and the increase is in direct proportion to the amount of thread interference and the thread engagement length over which this interference is maintained.

The addendum 522 of this exemplary embodiment defines a cross section profile that extends radially outward from the leading and trailing face profile of the external thread. It can be defined an associated addendum leading edge and addendum trailing edge that are each approximately linear. In this example the addendum leading edge is a straight line extension of the leading face while the addendum trailing edge generates desired asymmetry by defining a trailing edge addendum angle (see AT in FIG. 6) that is lower/more-acute (with respect to the fastener's longitudinal axis 465 (FIG. 4)) than the prevailing angle of thread form's leading face with respect to the longitudinal axis.

The friction forces that were described generally above with reference to the prior art, are herein generated by a series of point contacts along the mating faces of the assembled threads according to this invention. The creation of such friction forces by the novel thread design of this invention is described below in more detail. Thus, the torque or rotational force that must be overcome, which is a result of the desired prevailing torque, has no need to be increased in order to overcome the face contact frictional forces that are developed in a system in accordance with the prior art. The control of the torque to overcome the prevailing torque is better established and more in accordance with assembly needs for tightening and thread locking. The limits to overcome the prevailing torque generated in the system of this invention are those directly related to the control of the thread interference.

With reference to FIG. 6 there is shown a schematic cross section of an assembled internal nut and bolt external thread (610 and 612, respectively) in accordance with an embodiment of this invention. The indicator of the interference pattern developed in the external and internal thread is denoted by the region 629 (as referenced in FIG. 5). The contact point 627 of the external thread 612 and adjacent contact point 628 of the internal thread 610 is derived from the radius external thread profile design (see radius region 614). The contact points 627, 628, combined with the contact between the lobular cross section of the externally threaded part (note lobularity in FIG. 7) and the trapezoidal internal thread 610, generate the applied pre-load that is induced by the tightening of the system in the direction of the arrow 633.

With reference now to FIG. 7 the lobularity of the thread transposes itself into a number of contact points per circumference of the screw system. The cross section of FIG. 7 denotes the contact at 627a/628a, 627b/628b and 627c/628c that would be in evidence where the internal nut thread is defined by a true circular cross section 731 and the external bolt thread is defined by a three-lobe (trilobe) cross section 732. Each cross section 731, 732 is centered about a common longitudinal axis 740. Although the illustration shows three lobes, it is expressly contemplated that any number of lobes will produce a desired point contact effect when developed in association with a radiused profile (614) on the externally threaded component and a trapezoidal nut thread that is of a circular cross section form in accordance with an illustrative embodiment of the present invention.

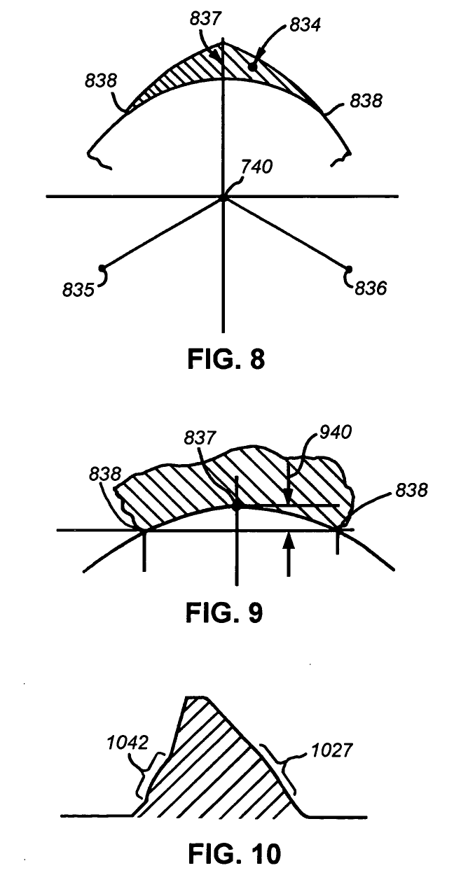

With reference now to FIG. 8 there is shown a schematic diagram of a cross section through the assembled external and internal threads in accordance with FIGS. 6 and 7. This diagram indicates the potential for variable stress, and in consequence strain 834, that is developed from the introduction of fastener system pre-load in accordance with an illustrative embodiment. The high stress is generally concentrated at the initial contact point 837 and tends to diminish to zero at a position 838 that is remote from the contact point 837. The distance that the stress/strain moves from a maximum (see 940 in FIG. 9) to zero is dependant upon factors such as the variable harnesses between the nut and bolt members and the magnitude of the applied pre-load. However, the result of these differing forces is to create indentations in the (typically) softer nut material in a manner illustrated in FIG. 9. Similar indentations will occur at all positions where the lobe and the radius thread profile coincide with the circular section of the nut threads, 835, 836 etc. These indentations will be maintained at all times that the system pre-load is retained and mechanically assist the resistance for the nut and bolt threads against disengagement upon the application of external forces that might be applied to the jointed structure.

According to a further advantageous feature of the novel fastener system of this invention, during the initial application of the bolt/screw into the pre-threaded nut the prevailing torque for the system is limited to that resulting from the interference between the screw thread addendum and the nut thread form around its major diameter.

Torque is not detracted from that which has previously been taken to overcome thread friction at the mating contact faces and to deflect the state of the art thread profile to create the mating contact between the trapezoidal nut and bolt threads of known designs.

The system in accordance with the present invention has the distinct advantage of separating the prevailing torque from that needed to develop pre-load and thread locking such that better controls can be introduced into a fastener locking thread system.

With reference now to FIG. 10 there is shown a schematic of a thread profile in accordance with the present invention in which there is denoted a radius profile on both the trailing face 1027 and leading face 1042 of the thread form. This construction can enhance the strength of the mating threads by increasing the tensile and torsional strength of the externally threaded component. Notably, improved fastener stress area can be achieved as the overall thread form cross sectional area is increased without overly filling the area of the mating internal nut thread. A similar leading and trailing face radius profile is shown and described in my U.S. Pat. No. 5,722,808 (Pritchard), which is hereby expressly incorporated by reference.

The foregoing has been a detailed description of illustrative embodiments of the invention. Various modifications and additions can be made without departing from the spirit and scope of this invention. For example, the lead and root portions of the screw thread can define a variety of shapes designed for particular purposes. The pitch and size of the thread profile can also vary depending upon the material from which the internal thread is constructed. Other design parameters can also vary based upon the material of both the nut and screw. Accordingly this description is meant to be taken only by way of example and not to otherwise limit the scope of this invention.

What is claimed is:

1. A fastener system including an external thread formed on a shank for engaging an internal thread comprising:
an external thread profile defined by a leading face and a trailing face, the leading face sized and arranged to engage a portion of an adjacent profile of an internal thread cavity under predetermined preload; and
an asymmetrical thread addendum that extends radially outward from the leading face and trailing face constructed and arranged to prevent centralizing of the external thread within the internal thread cavity.

2. The fastener system as set forth in claim 1 wherein the external thread defines a lobular cross section in which the addendum extends radially into interference with a circular cross section of the internal thread cavity.

3. The fastener system as set forth in claim 2 wherein the external thread cross section defines at least three lobes.

4. The fastener system as set forth in claim 3 wherein the addendum defines a cross section profile having a leading and trailing edge that are each approximately linear, wherein the leading edge and the trailing edge each define a respective angle with respect to a longitudinal fastener axis that directs the addendum to a positioning that is biased toward the leading face.

5. A fastener system comprising:
an internal nut thread having a substantially circular cross sectional perimeter taken through a plane normal to a system longitudinal axis and an internal thread profile defining a substantially trapezoidal internal thread cavity with a leading face and a trailing face;
an external thread having a lobular cross sectional perimeter taken through a plane normal to the system longitudinal axis and an external thread profile defined by a leading face and a trailing face, the trailing face sized and arranged to engage a portion of an adjacent profile of the internal thread cavity under predetermined preload; and
an asymmetrical thread addendum that extends radially outward from the leading face and trailing face, the thread addendum being constructed and arranged to prevent centralizing of the external thread within the internal thread cavity.

6. The fastener system as set forth in claim 5 wherein the external thread cross section defines at least three lobes.

7. The fastener system as set forth in claim 6 wherein the addendum defines a cross section profile having a leading and trailing edge that are each approximately linear, wherein the leading edge and the trailing edge each define a respective angle with respect to a longitudinal fastener axis that directs the addendum to a positioning that is biased toward the leading face.
